(19) United States
(12) Patent Application Publication
(10) Pub. No.: US 2020/0372568 A1
(43) Pub. Date: Nov. 26, 2020

(54) MOBILE APPLICATION DATA BROKER

(71) Applicant: INTERNATIONAL BUSINESS MACHINES CORPORATION, Armonk, NY (US)

(72) Inventors: Corville O. Allen, Morrisville, NC (US); Kim Eric Wegner, Rochester, MN (US); Michele Chilanti, Rochester, MN (US)

(21) Appl. No.: 16/419,157

(22) Filed: May 22, 2019

(51) Int. Cl. G06Q 30/08; H04W 4/20; H04W 8/20

(52) U.S. Cl. CPC G06Q 30/08; H04W 8/20; H04W 4/20

(57) ABSTRACT

Exemplary embodiments described herein disclose a method, a computer program product, and a computer system for facilitating a consented exchange of data between mobile applications. A computer may be configured to receive registration information corresponding to one or more mobile applications, in addition to data publications and data subscriptions from the one or more mobile applications. Furthermore, the computer may be configured to receive a bid from a subscribing application for data of a publishing application, and forward the bid from the subscribing application to the publishing application. Moreover, the computer may be configured to determine whether the publishing application accepts the bid, as well as whether an owner of the data consents to the exchange. Lastly, the computer may be configured to process the exchange based on determining that both the publishing application and owner of the data consent to the proposed exchange.

### BACKGROUND

The present invention relates generally to data exchange, and more particularly to bartering the local exchange of data between mobile applications.

Mobile health, wellness, and fitness apps often require information obtained from different sources in order to express their full potential. For example, a diabetes management application would greatly benefit from consuming physical exercise information, while wellness applications would be interested in tracking blood glucose levels over time. With an increasing popularity of medical and fitness devices that can be readily connected to smart devices, the chances that such a plethora of information is being collected by a single smartphone is very high. However, different applications may still exclusively collect and store these different types of information, and therefore the information may never be consolidated for analysis by a single entity.

### SUMMARY

Exemplary embodiments described herein disclose a method, a computer program product, and a computer system for facilitating a consented exchange of data between mobile applications. A computer may be configured for receiving one or more first data publications from a first mobile application and one or more second data subscriptions from a second mobile application. The computer may be configured for, based on determining that a first portion the one or more second data subscriptions matches the first portion of the one or more first data publications, offering a bid from the second mobile application to the first mobile application to exchange the matching first portion and, based on the first mobile application accepting the bid from the second mobile application, processing the exchange.

In embodiments, the bid for the matching first portion may include compensation selected from a group comprising data, products, and services.

Moreover, embodiments may further comprise receiving one or more first data subscriptions from the first mobile application and receiving one or more second data publications from the second mobile application. Moreover, the first mobile application accepting the bid from the second mobile application may be further based on determining that a second portion of the one or more first data subscriptions matches the second portion of the one or more second data publications, and the bid may include the matching second portion.

In embodiments, processing the exchange may be further based on receiving consent from an owner of the published data.

Embodiments may further comprise, based on the first mobile application rejecting the bid from the second mobile application, receiving a counteroffer from the first mobile application and forwarding the counteroffer from the first mobile application to the second mobile application.

In some embodiments, receiving the one or more first data publications further comprises receiving one or more data sources, types, and quantities desired in exchange for the one or more first data publications, and processing the exchange may be further based on the bid including the desired one or more data sources, types, and quantities.

Moreover, embodiments may include, based on determining that the bid includes the desired one or more data sources, types, and quantities, processing the exchange without consent by an owner of the published and the subscribed data.

### BRIEF DESCRIPTION OF THE SEVERAL VIEWS OF THE DRAWINGS

The following detailed description, given by way of example and not intended to limit the invention solely thereto, will best be appreciated in conjunction with the accompanying drawings, in which:

FIG. 1 depicts a schematic diagram of a mobile device data broker system 100, in accordance with an embodiment of the present invention.

FIG. 2 depicts a flowchart illustrating the operations of a mobile device data broker 126 of the mobile device data broker system 100 in facilitating local data exchanges between the one or more mobile healthcare applications 132, in accordance with an embodiment of the present invention.

FIG. 3 depicts a block diagram depicting the hardware components of the mobile device data broker system 100 of FIG. 1, in accordance with an example embodiment of the present invention.

FIG. 4 depicts a cloud computing environment, in accordance with an embodiment of the present invention.

FIG. 5 depicts abstraction model layers, in accordance with an embodiment of the present invention.

The drawings are not necessarily to scale. The drawings are merely schematic representations, not intended to portray specific parameters of the invention. The drawings are intended to depict only typical embodiments of the invention. In the drawings, like numbering represents like elements.

### DETAILED DESCRIPTION OF THE SEVERAL VIEWS OF THE DRAWINGS

Detailed embodiments of the claimed structures and methods are disclosed herein; however, it can be understood that the disclosed embodiments are merely illustrative of the claimed structures and methods that may be embodied in various forms. Aspects may, however, be embodied in many different forms and should not be construed as limited to the exemplary embodiments set forth herein. Rather, these exemplary embodiments are provided for thoroughness and completeness in order to fully convey a scope of these embodiments to those skilled in the art. In the description, details of well-known features and techniques may be omitted to avoid unnecessarily obscuring the presented embodiments.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

In the interest of not obscuring the presentation of exemplary embodiments described herein, in the following detailed description, some processing steps or operations that are known in the art may have been combined together for presentation and for illustration purposes and in some instances may have not been described in detail. In other instances, some processing steps or operations that are known in the art may not be described at all. It should be understood that the following description is focused on the distinctive features or elements of the various presented embodiments.

Embodiments described herein disclose a method, computer program product, and system for a mobile device data broker system 100. In particular, exemplary embodiments described herein allow for the flexible exchange of data between applications on a mobile device, as will be described in greater detail herein. Key benefits include more granular, flexible, and transparent control over the data being shared between applications, rather than the traditional all or nothing approach of linking accounts at the service provider level. For example, users may agree to share exercise intensity data with a glucose monitoring application without necessarily having to share other data, such as their location and routes, which are similarly collected by the physical activity monitoring application. Importantly, sharing of the data occurs locally on the mobile or smart device itself, rather than at the back end, such that no linking of accounts is required. Detailed implementation follows.

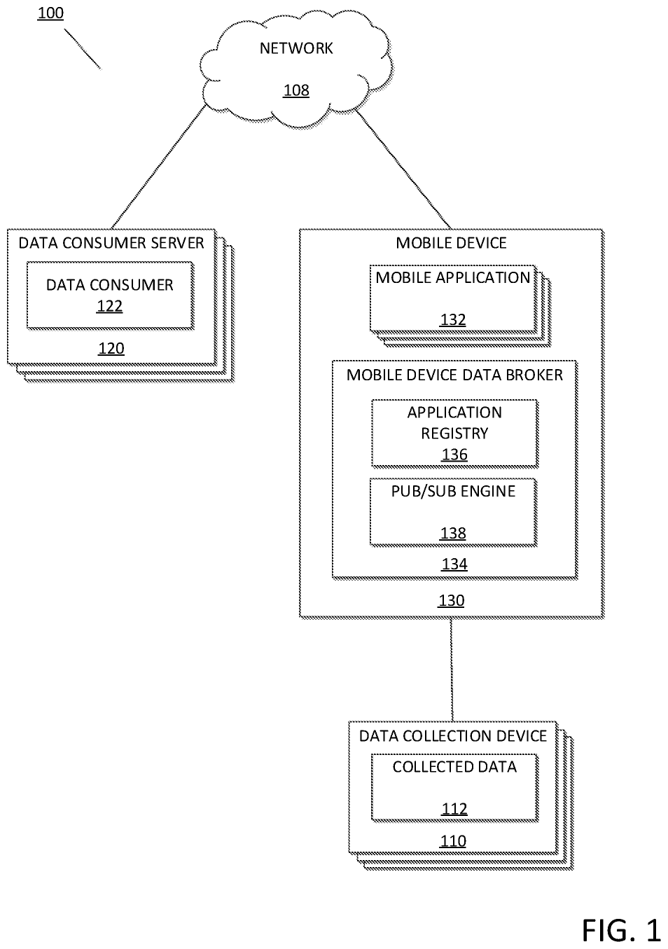

FIG. 1 depicts a mobile device data broker system 100, in accordance with an exemplary embodiment. The mobile device data broker system 100 may include one or more data collection devices 110, one or more medical data consumer servers 120, and a smart device 130, all interconnected via a network 108. While, in embodiments, programming and data described herein are stored and accessed remotely across one or more computing devices via the network 108, in other embodiments, programming and data described herein may be stored locally on as few as one physical computing device or amongst other computing devices than those depicted.

In embodiments, the network 108 may be a communication channel capable of transferring data between connected devices. For example, the network 108 may be the Internet, representing a worldwide collection of networks and gateways to support communications between devices connected to the Internet. Moreover, the network 108 may include, for example, wired, wireless, and/or fiber optic connections which may be implemented as an intranet network, a local area network (LAN), a wide area network (WAN), or a combination thereof. In further embodiments, the network 108 may be a Bluetooth network, a WiFi network, or a combination thereof. In yet further embodiments, the network 108 may be a telecommunications network used to facilitate telephone calls between two or more parties comprising a landline network, a wireless network, a closed network, a satellite network, or a combination thereof. In general, the network 108 may be any combination of connections and protocols that will support communications between connected devices.

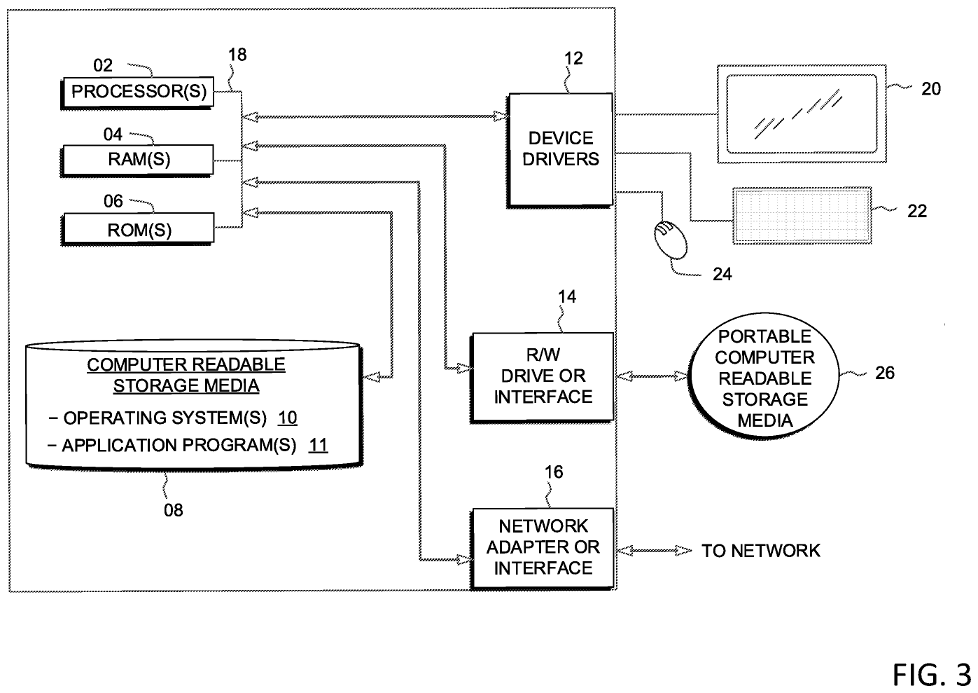

In the example embodiment, the one or more data collection devices 110 may include collected data 112, and may be any device capable of collecting, storing, processing, transmitting, and/or receiving data. In embodiments, for example, the data collection device 110 may be a device within an environment, such as a smart device, appliance, sensor, camera, microphone, etc. In other embodiments, the data collection device 110 may be a wearable device, such as glasses, a contact lens, watch/wristband, ring, anklet, headband, mouthpiece, and the like. In further embodiments, the data collection device 110 may be a special purpose-device such as an insulin pen, pacemaker, catheter, meter, implantable device, etc. Moreover, in embodiments, the data collection device 110 may include computing components used for collecting, processing, aggregating, and transmitting data, for example those depicted by FIG. 3. While the data collection device 110 is shown as a single device, in other embodiments, the data collection device 110 may be comprised of a cluster or plurality of computing devices, working together or working separately.

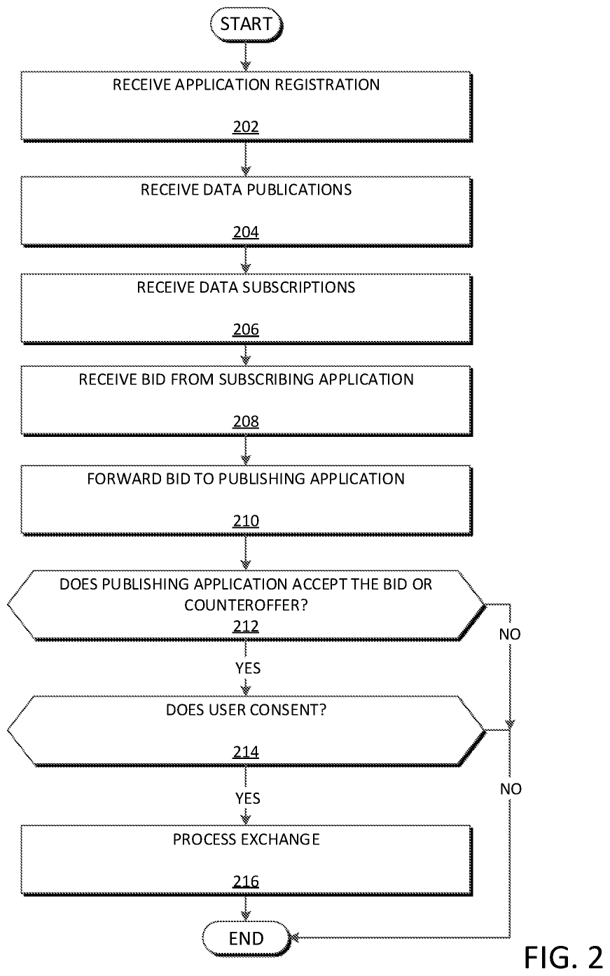

In the example embodiment, the collected data 112 may be data collected by and, in some embodiments, stored on the data collection device 110. In the example embodiment, the collected data 112 may include data contained in files, folders, and other document types, and may be structured (i.e., organized into a formatted repository), partially structured, or unstructured. The collected data 112 may be written in programming languages of common file formats such as csv, .docx, .doc, .pdf, .rtf, etc. In embodiments, such data may be owned by the user of the data collection device 110, and therefore transfer of the collected data 112 may be subject to consent and privacy laws. Accordingly, the collected data 112 may be held to strict security standards and/or encrypted, when necessary. The collected data 112 is described in greater detail with respect to FIG. 2.

In the example embodiment, the one or more data consumer servers 120 may include a data consumer 122 and may be an enterprise server, a laptop computer, a notebook, a tablet computer, a netbook computer, a personal computer (PC), a desktop computer, a server, a personal digital assistant (PDA), a rotary phone, a touchtone phone, a smart phone, a mobile phone, a virtual device, a thin client, or any other electronic device or computing system capable of receiving and sending data to and from other computing devices. While the data consumer server 120 is shown as a single device, in other embodiments, the data consumer server 120 may be comprised of a cluster or plurality of computing devices, working together or working separately. The one or more data consumer servers 120 is described in greater detail with reference to FIG. 3.

In the example embodiment, the data consumer 122 may be an entity that utilizes the collected data 112 for various purposes. For example, the data consumer 122 may consume the collected data 112 in the form of medical data and be a pharmaceutical manufacturer, medical device maker, hospital, research center, institution, university, insurance company, and the like. In various embodiments, the data consumer 122 provides other data, services, products, monetary compensation, etc. as consideration in exchange for the collected data 112, as will be described in greater detail with respect to FIG. 2.

In the example embodiment, the mobile device 130 may include one or more mobile applications 132 and a mobile device data broker 134, and may be an enterprise server, a laptop computer, a notebook, a tablet computer, a netbook computer, a personal computer (PC), a desktop computer, a server, a personal digital assistant (PDA), a rotary phone, a touchtone phone, a smart phone, a mobile phone, a virtual device, a thin client, or any other electronic device or computing system capable of receiving and sending data to and from other computing devices. While the mobile device 130 is shown as a single device, in other embodiments, the mobile device 130 may be comprised of a cluster or plurality of computing devices, working together or working separately. The mobile device 130 is described in greater detail with reference to FIG. 3.

In the example embodiment, the one or more mobile applications 132 may be data tracking applications that are integrated with the data collection devices 110 in order to track and store the collected data 112. In embodiments, the mobile applications 132 may track various metrics, such as movement, nutrition levels, bodily function, exercise, blood glucose level, heart rate, steps taken, elevation, orientation, location, weather, humidity, etc.

In the example embodiment, the mobile device data broker 130 may include an application registry 136 and a pub/sub engine 138. Moreover, the mobile device data broker 130 may be a hardware and/or software application configured to receive registration information corresponding to one or more mobile applications. In addition, the mobile device data broker 130 may be configured to receive data publications and data subscriptions from the one or more registered mobile applications. Furthermore, the mobile device data broker 130 may be configured to receive a bid from a subscribing application for data of a publishing application, and forward the bid from the subscribing application to the publishing application. Moreover, the mobile device data broker 130 may be configured to determine whether the publishing application accepts the bid, as well as whether an owner of the data consents to the exchange. Lastly, the mobile device data broker 130 may be configured to process the exchange based on determining that both the publishing application and owner of the data consent to the proposed exchange. The operations of the mobile device data broker 130 are described in greater detail with respect to FIG. 2.

In the example embodiment, the application registry 136 may be a document that tracks the registration information of the one or more mobile applications 132 and, in embodiments, a corresponding one or more data consumers 122. In embodiments, the application registry 136 may further include a listing (or data itself) of the available collected data 112 each of the mobile applications 132 has available for publishing as well as the collected data 112 each of the mobile applications 132 requests to exchange through subscribing. The application registry 136 is described in greater detail with respect to FIG. 2.

In the example embodiment, the pub/sub engine 138 may be a publish and subscription pattern used to facilitate exchanges of the collected data 112 between the one or more mobile applications 132. In particular, the mobile device data broker 130 publishes the collected data 112 in the pub/sub engine 138 such that the mobile device data broker 130 may identify the mobile applications 132 that may be subscribed to the types, quantities, etc. of the published, collected data 112. In the example embodiment, the pub/sub engine 138 merely lists the published and subscribed collected data 112 however, in other embodiments, may store the collected data 112 itself, as well.

FIG. 2 illustrates the operations of the mobile device data broker 130 of the mobile device data broker system 100 in facilitating data exchanges between the one or more mobile applications 132, in accordance with an embodiment of the present invention.

The mobile device data broker 130 may receive application registration information corresponding to the one or more mobile applications 132 (step 202). In the example embodiment, the registration information may include information such as an application name, application id, owner (or corresponding data consumer 122), owner location, owner contact information, serial number, permissions, corresponding data collection device(s) 110, and the like. The mobile device data broker 130 may receive registration of the one or more mobile applications 132 at a time they are initially installed, when additional data collection devices 110 are added, when additional collected data 112 is added, on demand, etc., and the mobile device data broker 130 may store the registration information in the application registry 136.

To further illustrate the operations of the mobile device data broker 130, reference is now made to an illustrative example where a user installs on a mobile device a diabetes management application that collects blood-glucose readings, medication administrations, and food consumption data. In addition, the user utilizes a physical activity monitoring application that collects data regarding physical activity, such as type of exercise, duration of exercise, and calories burned.

The mobile device data broker 130 may receive data publications from the one or more mobile applications (step 204). In the example embodiment, the data publications may refer to the collected data 112 that the one or more mobile applications 132 are offering for exchange. The mobile device data broker 130 may publish such data publications in the pub/sub engine 138, which are later cross-referenced with subscriptions indicative of the collected data 112 desired by one or more other mobile applications 132, described in greater detail below. In the example embodiment, the published data may be specified by type, amount, quality, date, etc. such that the one or more mobile applications 132 may exchange the collected data 112 in a more granular and flexible manner. While it is not necessary for the mobile device data broker 130 to extract the collected data 112 itself that is designated to be published from the data collection device 110/the mobile device 130 at this time, some embodiments of the present invention may configure the mobile device data broker 130 to extract the collected data 112 at the time of registration/publication, upon detection of a new instance of the data collection device 110, on demand, at subsequent intervals, etc. In such embodiments, the mobile device data broker 130 may be configured to retrieve the collected data 112, for example securely extracting the collected data 112 from the data collection device 110/the mobile device 130 or receiving user-uploaded data. In other embodiments, however, the mobile device data broker 130 may be configured to only transfer the collected data 112 once an exchange is agreed upon.

In furthering the earlier-introduced example, the mobile device data broker 130 receives from the diabetes monitoring application a request to publish blood-glucose readings, medication administrations, and food consumption data. In addition, the mobile device data broker 130 receives from the exercise monitoring application a request to publish exercise type, exercise duration, and calories burned data.

The mobile device data broker 130 may receive data subscriptions from the one or more mobile applications 132 (step 206). In the example embodiment, the data subscriptions may refer to the collected data 112 that the one or more mobile applications 132 are seeking and are similarly listed and/or stored in the pub/sub engine 138. In the example embodiment, the subscriptions include information relating to the collected data 112 of interest, such as desired sources, desired types, sufficient amounts (thresholds) in total/by type, rarity by source/type/occurrence, events of interest, and the like. Note that for particular requests, the one or more mobile applications 132 may be required to include definitions as to what constitutes rare occurrences and/or events of interest using medical code or a descriptive string. Moreover, the mobile device data broker 130 may receive a compensation or offer that the one or more mobile applications 132 (or, ultimately, the data consumer 122) is willing to provide in exchange for said collected data 112. In embodiments, the mobile device data broker 134 may further receive from the data consumer 122 preferred patient groups, frequency of exchange, etc.

Continuing the example introduced above, the mobile device data broker 130 receives from the diabetes monitoring application a request to subscribe to calories burned and exercise duration data, which can be correlated with blood-glucose levels. In addition, the mobile device data broker 130 receives from the exercise monitoring application a request to subscribe to food consumption data, which can be correlated with exercise performance.

The mobile device data broker 130 may receive a bid from an offering mobile application 132 for all or a portion of the published data (step 208). In the example embodiment, when the mobile device data broker 130 determines that a subscribed collected data 112 of a mobile application 132 (the subscriber) matches the published collected data 112 of a publishing mobile application 132 (the publisher), the mobile device data broker 130 will alert the subscriber that there is a published match such that the subscriber can place a bid for the matching published collected data 112. In some embodiments, the bid may comprise an indication that the subscriber seeks portions and/or all of the published collected information 112, and the publisher may then request portions and/or all of the collected data published by the subscriber in exchange. In other embodiments, the bid may include portions and/or all of the collected data 112 that the subscriber is willing to exchange with the publisher or other forms of compensation, such as monetary compensation, products, services, etc. In the case that a subscriber and publisher both have portions and/or all of the collected data 112 that are of mutual interest to each other and the exchange is within any bounds sets by the mobile applications 132 at registration/publishing, such as data type, exchange rate, quantity, etc., the mobile device data broker 130 may automatically process the transaction without input from a user/administrator, the one or more mobile applications 132, and/or the data consumer 122.

With reference again to the previously introduced example, the mobile device data broker 130 receives from the diabetes monitoring application a bid for the calories burned and exercise duration data of the exercise monitoring application. In some embodiments, the bid may include an offer to exchange food consumption data for the calories burned and exercise duration data. In other embodiments, the bid may be open ended or offer other compensation.

The mobile device data broker 130 may forward the bid from the subscriber to the publisher (step 210). If the mobile device data broker 130 determines, upon receiving the bid, that it cannot automatically process the exchange, for example due to the exchange not being within prescribed bounds, the mobile device data broker 130 will forward the bid to the publisher. As mentioned above, the bid may include an open-ended intent to exchange, the collected data 112 the subscriber offers in exchange, other monetary/service/products offered for exchange, and the like. Upon receipt, the publisher is presented with options to accept the bid, reject the bid, counteroffer, conditionally accept based on specified requisites (e.g., additional data, etc.), and other options for responding to the bid. In addition to the options, the mobile device data broker 130 may additionally link the collected data 112 published by the subscriber/offeror such that the publisher can provide a counteroffer. In addition, the bid may be further presented with actions to modify aspects of the bid as well as text fields to customize an offer. In the case that a publisher receives multiple bids, particularly those that overlap, the publisher may be presented all of the offers side-by-side for comparison and select those bids, or portions thereof, that the publisher chooses to accept.

Referring now to the formerly introduced illustrative example, the mobile device data broker 130 forwards to the exercise application (or an administrator thereof, if not configured to automated processing) the bid for calories burned and exercise duration data generated by the diabetes application. In embodiments, the bid may include the data offered by the diabetes application in exchange, while in others the bid may be open-ended.

The mobile device data broker 130 may determine whether the publisher accepts the bid or provides a counteroffer (decision 212). In the example embodiment, the mobile device data broker 130 determines whether the publisher has accepted the bid or provided a counteroffer via communication with the one or more mobile applications 132. In other embodiments, the mobile device data broker 130 may be configured to automatically accept bids in certain circumstances. For example, if two of the mobile applications 132 have published collected data 112 of mutual interest and the mobile applications 132 are configured to automatically exchange the collected data 112 if the parameters of the exchange fall within prescribed bounds, the mobile device data broker 130 may autonomously accept the bid. Alternatively, the mobile device data broker 130 may be configured to accept bids that offer to exchange the collected data 112 in a particular field or with specified characteristics, such as always accept bids when a threshold amount of medical or bug/defect information is offered in exchange. In further embodiments, the mobile device data broker 130 may be configured to accept bids exceeding a threshold value or providing a particular product/service. Additionally, a publisher may provide a counteroffer to the bid or provide an offer in response to receiving an open-ended bid. In the example embodiment, a counteroffer may be placed by responding to an open-ended bid or modifying the terms of a bid. In embodiments, the mobile applications 132 may be configured with a prioritized list of desirable versions of the collected data 112 such that exchanges meeting any prescribed criteria are autonomously processed. In such embodiments, the mobile device data broker 130 may be configured to facilitate any number of counterproposals until an exchange is mutually agreed upon.

With reference again to the illustrative example, the mobile device data broker 130 determines whether the bid is accepted or counteroffered by the exercise application via communication with the exercise application.

Based on determining that the bid has been accepted (decision 212, “YES” branch), the mobile device data broker 130 may determine whether a user consents to the exchange (decision 214). In embodiments, the mobile device data broker 130 may first obtain consent from a user, or owner of the collected data 112, in order to process the exchange. In such embodiments, the mobile device data broker 130 may present to the user the exchange as well as options to approve or deny the exchange via text message, email, push notification, etc., which the mobile device data broker 130 detects via communication with the smart device 130. Note that this step may not be necessary, should the one or more mobile applications 132 be configured for automated exchanges and processing.

Returning to the previously introduced example, the mobile device data broker 130 determines whether a user of the smart device approves the exchange of calories burned and exercise duration data of the exercise monitoring application for the food consumption data of the diabetes monitoring application.

Based on determining that the user consents to the exchange (decision 214, “YES” branch), the mobile device data broker 130 may process the exchange (step 216). In the example embodiment, the mobile device data broker 130 processes the exchange by transmitting the collected data 112 subject to the exchange between the mobile applications 132.

With reference to the previously introduced example, the mobile device data broker 130 transfers the food consumption data from the exercise monitoring application to the diabetes monitoring application in exchange for exercise duration and calories burned data.

If the mobile device data broker 130 determines that the publishing application does not accept the bid (decision 212, “NO” branch) or that the user does not consent to the exchange (decision 214, “NO” branch), then the mobile device data broker 130 may end.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

FIG. 3 depicts a block diagram of devices within the mobile device data broker system 100 of FIG. 1, in accordance with an embodiment of the present invention. It should be appreciated that FIG. 3 provides only an illustration of one implementation and does not imply any limitations with regard to the environments in which different embodiments may be implemented. Many modifications to the depicted environment may be made.

Devices used herein may include one or more processors 02, one or more computer-readable RAMs 04, one or more computer-readable ROMs 06, one or more computer readable storage media 08, device drivers 12, read/write drive or interface 14, network adapter or interface 16, all interconnected over a communications fabric 18. Communications fabric 18 may be implemented with any architecture designed for passing data and/or control information between processors (such as microprocessors, communications and network processors, etc.), system memory, peripheral devices, and any other hardware components within a system.

One or more operating systems 10, and one or more application programs 11 are stored on one or more of the computer readable storage media 08 for execution by one or more of the processors 02 via one or more of the respective RAMs 04 (which typically include cache memory). In the illustrated embodiment, each of the computer readable storage media 08 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Devices used herein may also include a R/W drive or interface 14 to read from and write to one or more portable computer readable storage media 26. Application programs 11 on said devices may be stored on one or more of the portable computer readable storage media 26, read via the respective R/W drive or interface 14 and loaded into the respective computer readable storage media 08.

Devices used herein may also include a network adapter or interface 16, such as a TCP/IP adapter card or wireless communication adapter (such as a 4G wireless communication adapter using OFDMA technology). Application programs 11 on said computing devices may be downloaded to the computing device from an external computer or external storage device via a network (for example, the Internet, a local area network or other wide area network or wireless network) and network adapter or interface 16. From the network adapter or interface 16, the programs may be loaded onto computer readable storage media 08. The network may comprise copper wires, optical fibers, wireless transmission, routers, firewalls, switches, gateway computers and/or edge servers.

Devices used herein may also include a display screen 20, a keyboard or keypad 22, and a computer mouse or touchpad 24. Device drivers 12 interface to display screen 20 for imaging, to keyboard or keypad 22, to computer mouse or touchpad 24, and/or to display screen 20 for pressure sensing of alphanumeric character entry and user selections. The device drivers 12, R/W drive or interface 14 and network adapter or interface 16 may comprise hardware and software (stored on computer readable storage media 08 and/or ROM 06).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Based on the foregoing, a computer system, method, and computer program product have been disclosed. However, numerous modifications and substitutions can be made without deviating from the scope of the present invention. Therefore, the present invention has been disclosed by way of example and not limitation.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

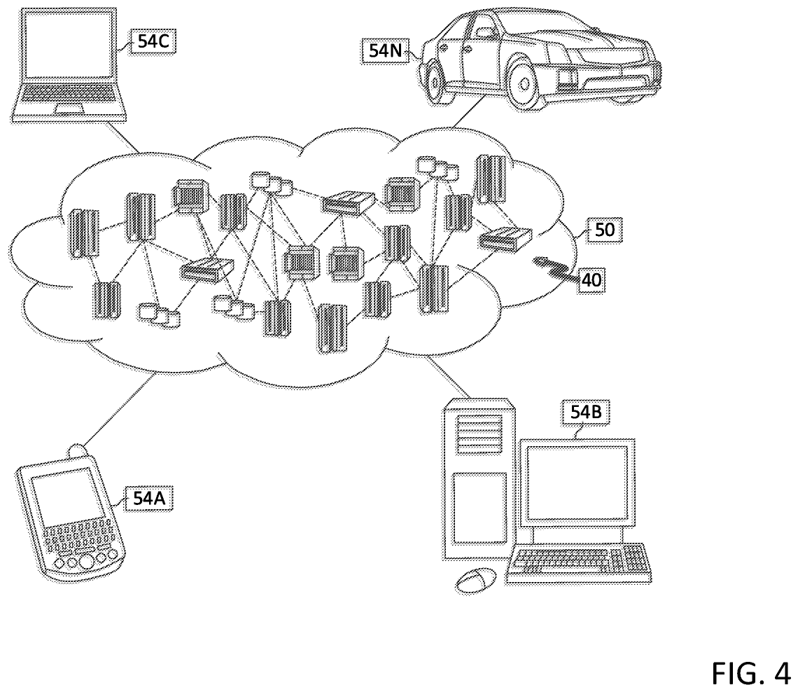

Referring now to FIG. 4, illustrative cloud computing environment 50 is depicted. As shown, cloud computing environment 50 includes one or more cloud computing nodes 40 with which local computing devices used by cloud consumers, such as, for example, personal digital assistant (PDA) or cellular telephone 54A, desktop computer 54B, laptop computer 54C, and/or automobile computer system 54N may communicate. Nodes 40 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 40 and cloud computing environment 50 can communicate with any type of computerized device over any type of network and/or network addressable connection (e.g., using a web browser).

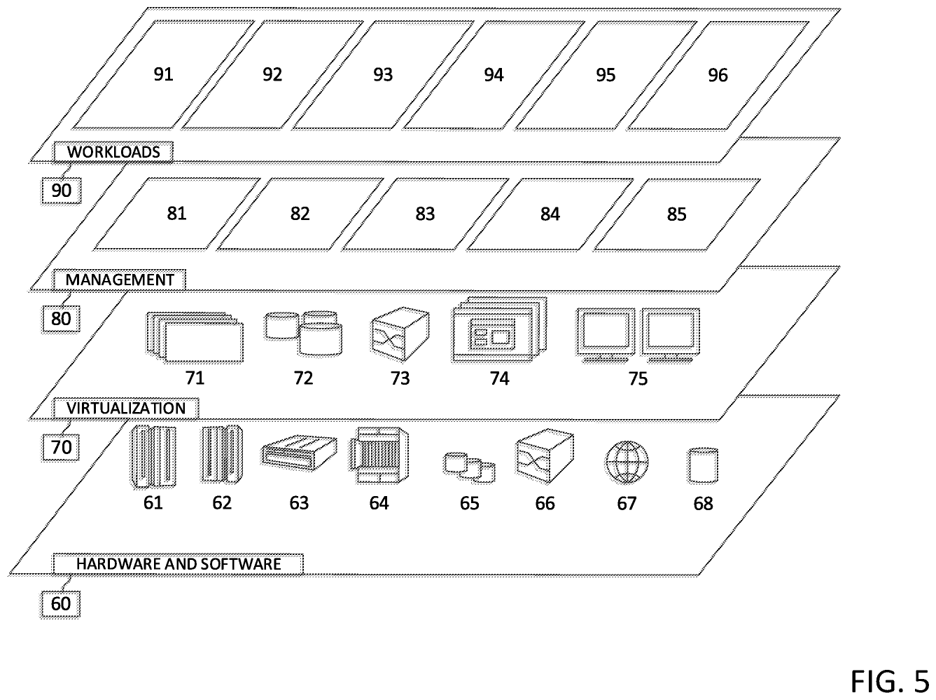

Referring now to FIG. 5, a set of functional abstraction layers provided by cloud computing environment 50 (FIG. 5) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and exchange processing 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer-implemented method for facilitating a consented exchange of data between mobile applications, the method comprising:
receiving one or more first data publications from a first mobile application;
receiving one or more second data subscriptions from a second mobile application;
based on determining that a first portion the one or more second data subscriptions matches the first portion of the one or more first data publications, offering a bid from the second mobile application to the first mobile application to exchange the matching first portion; and
based on the first mobile application accepting the bid from the second mobile application, processing the exchange.

2. The method of claim 1, wherein the bid for the matching first portion includes compensation selected from a group comprising data, products, and services.

3. The method of claim 1, further comprising:
receiving one or more first data subscriptions from the first mobile application;
receiving one or more second data publications from the second mobile application; and
wherein the first mobile application accepting the bid from the second mobile application is further based on determining that a second portion of the one or more first data subscriptions matches the second portion of the one or more second data publications; and
wherein the bid includes the matching second portion.

4. The method of claim of claim 1, wherein processing the exchange is further based on receiving consent from an owner of the published data.

5. The method of claim 1, further comprising:
based on the first mobile application rejecting the bid from the second mobile application, receiving a counteroffer from the first mobile application; and
forwarding the counteroffer from the first mobile application to the second mobile application.

6. The method of claim 1, wherein receiving the one or more first data publications further comprises:
receiving one or more data sources, types, and quantities desired in exchange for the one or more first data publications; and
wherein processing the exchange is further based on the bid including the desired one or more data sources, types, and quantities.

7. The method of claim 6, further comprising:
based on determining that the bid includes the desired one or more data sources, types, and quantities, processing the exchange without consent by an owner of the published and the subscribed data.

8. A computer program product for facilitating a consented exchange of data between mobile applications, the computer program product comprising:
one or more non-transitory computer-readable storage media and program instructions stored on the one or more non-transitory computer-readable storage media capable of performing a method, the method comprising:
receiving one or more first data publications from a first mobile application;
receiving one or more second data subscriptions from a second mobile application;
based on determining that a first portion the one or more second data subscriptions matches the first portion of the one or more first data publications, offering a bid from the second mobile application to the first mobile application to exchange the matching first portion; and
based on the first mobile application accepting the bid from the second mobile application, processing the exchange.

9. The computer program product of claim 8, wherein the bid for the matching first portion includes compensation selected from a group comprising data, products, and services.

10. The computer program product of claim 8, further comprising:
receiving one or more first data subscriptions from the first mobile application;
receiving one or more second data publications from the second mobile application; and
wherein the first mobile application accepting the bid from the second mobile application is further based on determining that a second portion of the one or more first data subscriptions matches the second portion of the one or more second data publications; and
wherein the bid includes the matching second portion.

11. The computer program product of claim 8, wherein processing the exchange is further based on receiving consent from an owner of the published data.

12. The computer program product of claim 8, further comprising:
based on the first mobile application rejecting the bid from the second mobile application, receiving a counteroffer from the first mobile application; and
forwarding the counteroffer from the first mobile application to the second mobile application.

13. The computer program product of claim 8, wherein receiving the one or more first data publications further comprises:
receiving one or more data sources, types, and quantities desired in exchange for the one or more first data publications; and
wherein processing the exchange is further based on the bid including the desired one or more data sources, types, and quantities.

14. The computer program product of claim 13, further comprising:
based on determining that the bid includes the desired one or more data sources, types, and quantities, processing the exchange without consent by an owner of the published and the subscribed data.

15. A computer system for facilitating a consented exchange of data between mobile applications, the computer system comprising:
one or more computer processors, one or more computer-readable storage media, and program instructions stored on one or more of the computer-readable storage media for execution by at least one of the one or more processors capable of performing a method, the method comprising:
receiving one or more first data publications from a first mobile application;
receiving one or more second data subscriptions from a second mobile application;
based on determining that a first portion the one or more second data subscriptions matches the first portion of the one or more first data publications, offering a bid from the second mobile application to the first mobile application to exchange the matching first portion; and
based on the first mobile application accepting the bid from the second mobile application, processing the exchange.

16. The computer system of claim 15, wherein the bid for the matching first portion includes compensation selected from a group comprising data, products, and services.

17. The computer system of claim 15, further comprising:
receiving one or more first data subscriptions from the first mobile application;
receiving one or more second data publications from the second mobile application; and
wherein the first mobile application accepting the bid from the second mobile application is further based on determining that a second portion of the one or more first data subscriptions matches the second portion of the one or more second data publications; and
wherein the bid includes the matching second portion.

18. The computer system of claim 15, wherein processing the exchange is further based on receiving consent from an owner of the published data.

19. The computer system of claim 15, further comprising:
based on the first mobile application rejecting the bid from the second mobile application, receiving a counteroffer from the first mobile application; and
forwarding the counteroffer from the first mobile application to the second mobile application.

20. The computer system of claim 15, wherein receiving the one or more first data publications further comprises:
receiving one or more data sources, types, and quantities desired in exchange for the one or more first data publications; and
wherein processing the exchange is further based on the bid including the desired one or more data sources, types, and quantities.
